(19) United States
(12) Patent Application Publication
(10) Pub. No.: US 2021/0390875 A1
(43) Pub. Date: Dec. 16, 2021

(54) SYSTEM AND METHOD FOR PROVIDING BEHAVIORAL-BASED PERSONALIZED NUDGES FOR CREATING SAVINGS GOALS

(71) Applicant: INTUIT INC., Mountain View, CA (US)

(72) Inventors: Nirmala RANGANATHAN, Mountain View, CA (US); Yair HORESH, Tel Aviv (IL); Yehezkel Shraga RESHEFF, Tel Aviv (IL); Kymm K. KAUSE, Mountain View, CA (US); Daniel Ben DAVID, Tel Aviv (IL)

(73) Assignee: INTUIT INC., Mountain View, CA (US)

(21) Appl. No.: 16/897,476

(22) Filed: Jun. 10, 2020

(51) Int. Cl. G09B 19/00; G06Q 40/02; G06Q 40/06; G06N 20/00; G06N 7/00; G06F 17/16

(52) U.S. Cl. CPC G09B 19/00; G06Q 40/02; G06F 17/16; G06N 20/00; G06N 7/005; G06Q 40/06

(57) ABSTRACT

Systems and methods that may be used to provide personalized financial nudges to users of a financial service that may be used to further the users' savings intentions (e.g., a savings goal, an emergency fund, etc.). The disclosed systems and methods may increase user interactivity with the financial service and the services it offers by providing personalized nudges that are based on, among other things, an evaluation of various behavioral economics principles. A machine learning recommendation system may be used to fit and output different nudges to users in a personalized way to maximize their savings' intentions.

### BACKGROUND

Currently, large debt and poor saving habits are at epidemic levels across the United States. It is estimated that 45% of Americans live paycheck to paycheck. Significantly, it is estimated that 40% of Americans could not come up with $400 if needed for an emergency situation. Mortgage and student loan debt are at all-time highs, causing finances to be the number one stressor for American households.

There are online and computerized financial services that help users with their finances. For example, these services may allow users to track bank, credit card, investment, and loan balances and or financial transactions. These services may also allow users to create budgets. Unfortunately, a user promising to stay within budget or spend its money it wisely is far different from the user actually staying within budget and spending its money wisely. Without more, many users may simply continue their bad habits and never get the debt relief they are looking for.

### BRIEF DESCRIPTION OF THE FIGURES

FIG. 1 shows an example of a system configured to implement a behavioral-based personalized nudges process in accordance with an embodiment of the present disclosure.

FIG. 2 shows a server device according to an embodiment of the present disclosure.

FIG. 3 shows an example behavioral-based personalized nudges process according to an embodiment of the present disclosure.

FIG. 4 shows an example process for re-training a model used in the process illustrated in FIG. 3.

FIG. 5 shows an example evaluation matrix that may be used in the behavioral-based personalized nudges process according to an embodiment of the present disclosure.

FIGS. 6-8 show example nudges that may be provided in accordance with the disclosed principles.

### DETAILED DESCRIPTION OF SEVERAL EMBODIMENTS

Embodiments described herein may be used to provide personalized financial nudges to users of a financial service that may be used to further the users' savings intentions (e.g., a savings goal, an emergency fund, etc.). Embodiments described herein may also increase user interactivity with the financial service and the services it offers by providing personalized nudges that are based on, among other things, an evaluation of various behavioral economics principles. In one or more embodiments, a machine learning recommendation system may be used to fit and output different nudges to users in a personalized way to maximize their savings' intentions.

As is known in the art, a nudge is a concept in behavioral science and behavioral economics that proposes positive reinforcement and indirect suggestions as ways to influence the behavior and decision making of one or more individuals. A nudge makes it more likely that an individual will make a particular choice, or behave in a particular way, by triggering an individual's automatic cognitive processes to favor a desired outcome. In accordance with the disclosed principles, it is desirable to provide personalized nudges to users so that they are more likely to accept and or follow the provided nudges to further their savings intentions and continue to interact with the service. Current financial systems do not have these capabilities, which is undesirable.

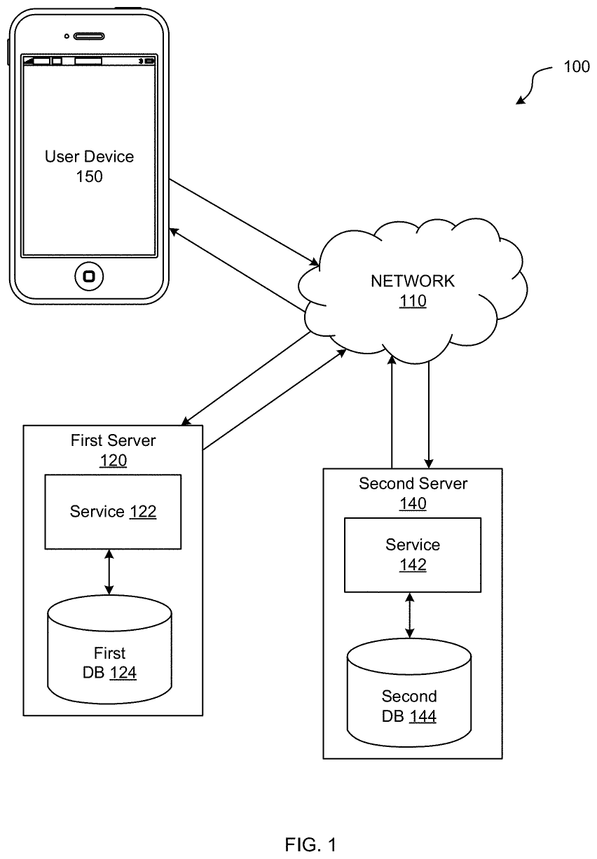

FIG. 1 shows an example of a system 100 configured to implement a behavioral-based personalized nudges process according to an embodiment of the present disclosure. System 100 may include a first server 120, second server 140, and/or a user device 150. First server 120, second server 140, and/or user device 150 may be configured to communicate with one another through network 110. For example, communication between the elements may be facilitated by one or more application programming interfaces (APIs). APIs of system 100 may be proprietary and/or may be examples available to those of ordinary skill in the art such as Amazon® Web Services (AWS) APIs or the like. Network 110 may be the Internet and/or other public or private networks or combinations thereof.

First server 120 may be configured to implement a first service 122, which in one embodiment may be used to input data suitable for implementing the behavioral-based personalized nudges process in accordance with the disclosed principles. For example, as discussed below in more detail, experimental and or test data from more than a hundred thousand system users may be input, labeled and used to train a classification model that may be used to evaluate and fit different nudges to different users. In one or more embodiments, the data may be input via network 110 from one or more databases 124, 144, the second server 140 and/or user device 150. For example, first server 120 may execute the behavioral-based personalized nudges process according to an embodiment of the present disclosure using data stored in database 124, database 144 and or received from second server 140 and/or user device 150. First service 122 or second service 142 may implement a financial service and or information service, which may maintain data used throughout the process disclosed herein. The financial and or information service may be any network 110 accessible service such as Mint® and its variants, offered by Intuit® of Mountain View Calif.

User device 150 may be any device configured to present user interfaces and receive inputs thereto. For example, user device 150 may be a smartphone, personal computer, tablet, laptop computer, or other device.

First server 120, second server 140, first database 124, second database 144, and user device 150 are each depicted as single devices for ease of illustration, but those of ordinary skill in the art will appreciate that first server 120, second server 140, first database 124, second database 144, and/or user device 150 may be embodied in different forms for different implementations. For example, any or each of first server 120 and second server 140 may include a plurality of servers or one or more of the first database 124 and second database 144. Alternatively, the operations performed by any or each of first server 120 and second server 140 may be performed on fewer (e.g., one or two) servers. In another example, a plurality of user devices 150 may communicate with first server 120 and/or second server 140. A single user may have multiple user devices 150, and/or there may be multiple users each having their own user device(s) 150.

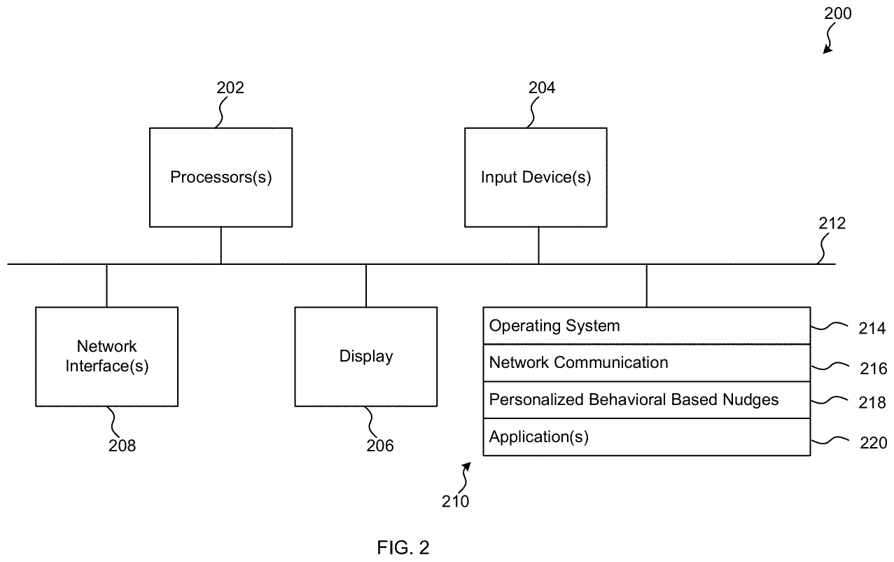

FIG. 2 is a block diagram of an example computing device 200 that may implement various features and processes as described herein. For example, computing device 200 may function as first server 120, second server 140, or a portion or combination thereof in some embodiments. The computing device 200 may be implemented on any electronic device that runs software applications derived from compiled instructions, including without limitation personal computers, servers, smart phones, media players, electronic tablets, game consoles, email devices, etc. In some implementations, the computing device 200 may include one or more processors 202, one or more input devices 204, one or more display devices 206, one or more network interfaces 208, and one or more computer-readable media 210. Each of these components may be coupled by a bus 212.

Display device 206 may be any known display technology, including but not limited to display devices using Liquid Crystal Display (LCD) or Light Emitting Diode (LED) technology. Processor(s) 202 may use any known processor technology, including but not limited to graphics processors and multi-core processors. Input device 204 may be any known input device technology, including but not limited to a keyboard (including a virtual keyboard), mouse, track ball, and touch-sensitive pad or display. Bus 212 may be any known internal or external bus technology, including but not limited to ISA, EISA, PCI, PCI Express, USB, Serial ATA or FireWire. Computer-readable medium 210 may be any medium that participates in providing instructions to processor(s) 202 for execution, including without limitation, non-volatile storage media (e.g., optical disks, magnetic disks, flash drives, etc.), or volatile media (e.g., SDRAM, ROM, etc.).

Computer-readable medium 210 may be a non-transitory computer-readable medium and may include various instructions 214 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 204; sending output to display device 206; keeping track of files and directories on computer-readable medium 210; controlling peripheral devices (e.g., disk drives, printers, etc.) which can be controlled directly or through an I/O controller; and managing traffic on bus 212. Network communications instructions 216 may establish and maintain network connections (e.g., software for implementing communication protocols, such as TCP/IP, HTTP, Ethernet, telephony, etc.).

Personalized behavioral-based nudges instructions 218 may include instructions that implement the behavioral-based personalized nudges process described herein. Application(s) 220 may be an application that uses or implements the processes described herein and/or other processes. The processes may also be implemented in operating system 214.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

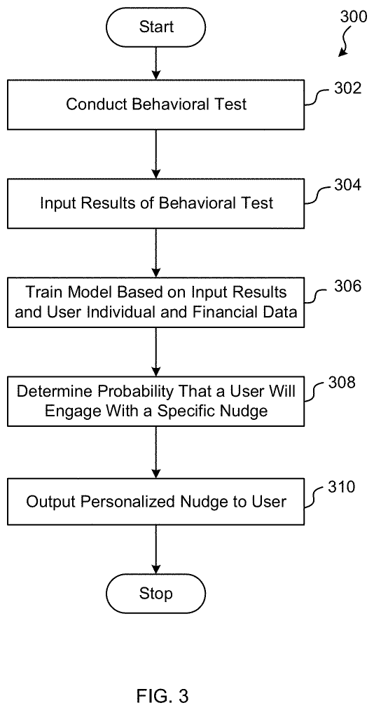

FIG. 3 illustrates an example behavioral-based personalized nudges process 300 in accordance with the principles disclosed herein. In one embodiment, system 100 may perform some or all of the processing illustrated in FIG. 3. For example, first server 120 may execute the steps of the process 300 as part of the first service 122 (e.g., a financial service). The first server 120 and or first service 122 may input and or use data from, or store processed data in, one or more of the first database 124, second database 144 and or user device 150.

At step 302, the process 300 may conduct a behavioral test using predetermined select users of the first service 122 and or system 100. In one or more embodiments, the behavioral test may be a multivariate test, meaning that more than one variable may be changed at a time throughout the testing. In one or more embodiments, the process 300 may send different messages (e.g., email messages) to select users with each message containing a nudge and or question based on one of a plurality of behavioral principles. The messages may be designed to elicit one or more responses from the users. For example, a message may seek a selection of a link and or other interactive response from a user. In one or more embodiments, the simple act of a user opening up the email message may be the desired response, or part of the desired response.

As is known in the art, there are many types of behavioral principles that could be used to formulate the nudges for the multivariate behavioral test. Example behavioral principles that may be used in accordance with the disclosed principles, include, but are not limited to anchoring, positive framing, negative framing, peer effects, bandwagon effect, social norms, customization-control, simplification, empowerment, to name a few. These behavioral principles are well known and their respective descriptions are not provided herein for brevity purposes.

In one or more embodiments, the message header and or message body may contain a nudge formulated using one of the plurality of behavioral principles used in the process 300. For example, a message based on the negative framing behavioral principle may include a header or body portion comprising the message “Avoid stressing when the unexpected happens” while a message based on the peer effects behavioral principle may include a header or body portion comprising the message “Savvy people like you start a rainy day fund.”

In one or more embodiments, the predetermined select users may be users that have a positive net cash-flow and or no credit card debt. This information may be stored in the first database 124 or any storage medium accessible by the first service 122. As can be appreciated, these users have good financial habits and are more likely to have savings intentions such as e.g., a savings goal and or emergency fund, and are more likely to adhere to them and work towards achieving them. In one or more embodiments, the messages may be sent at random to the select users so that behavioral nudges and their underlying behavioral principle are randomly sent to the users.

At step 304, the process 300 may input the results of the behavioral test initiated at step 302. In one or more embodiments, the input results may be a user activation of a link and or a user answer to a prompt. In addition to, or alternatively, the input results may be another interaction by the user that may be tracked by the process 300 such as e.g., the opening up of the message or the failure to open the message within a predetermined time period. The input results may be referred to herein as “test results.”

At step 306, the process 300 may use the input test results as part of a training feature dataset to train a classification machine learning model (referred to herein as the “behavioral classification model”). In one or more embodiments, in addition to the input test results, the training feature dataset may include individual user data (e.g., age, gender, marital status), financial data (e.g., income/expenses ratios, debt and savings information) and the different behavioral principles used in the behavioral test. The target variable for the model may include open-rates (e.g., the percentage of the total number of opened messages to messages sent), click-through-rates (e.g., the percentage of users who accessed a link within the messages), a user creating a savings goals and or any other savings target metric offered by the service.

The disclosed principles may include any known classification model as the behavioral classification model. A classification model attempts to draw one or more conclusions from the input values given to it for training. A classification model output is often a probability number for the dataset typically between 0 and 1. Types of classification models that may be used for the behavioral classification model include, but are not limited to, logistic regression, Naïve Bayes, stochastic gradient descent, K-nearest neighbors, decision tree, random forest, support vector machine (SVM), xgboost, and convolutional neural network (CNN), to name a few.

In accordance with the disclosed principles, the trained classification model may calculate the probability that certain users will engage with one or more specific nudges or a combination of nudges. Accordingly, at step 308, the trained model may be used to create an evaluation matrix having the behavioral principles on one axis and another axis with possible nudge interactions (i.e., how the users may engage with or interact with the nudge) such as opening the nudge, clicking through the nudge, creation of a savings goal, etc. The intersection of the axes can be considered cells or matrix entries, which will be filled with the probabilities derived from the behavioral classification model's confidence levels (referred to herein as “behavior-based nudge probabilities”). In one or more embodiments, user individual and or financial data may be entered into the previously trained behavioral classification model, which may be run multiple times (e.g., one time for each behavioral principle used by the process 300) with the model's results (i.e., behavior-based nudge probabilities) being entered into the appropriate matrix cells.

In one or more embodiments, the process 300 may include the ability to mix and match behavioral principles and therefore different parts of the nudge such that the message to the user may contain different principles for maximization of the nudge. For example, the process 300 may determine that a combination of negative framing and anchoring may cause a user to be more engaged with the service. In this example, one or more components of the nudge (e.g., the push, header, and or message body) may be formed using negative framing and one or more components may be formed using anchoring.

At step 310, the process 300 may apply a policy for selecting the behavioral nudge or nudges that maximizes the target. For example, in accordance with the disclosed principles, the evaluation matrix may indicate that some users are triggered more by peer effects while others by loss aversion. As such, a nudge based on peer effects may be output to the user, providing a personalized nudge determined to be appropriate for the user.

In one or more embodiments, the disclosed principles may re-train the behavioral classification model based on user responses or interactions with personalized nudges over time (i.e., user interaction with personalized nudges output at step 310). It is anticipated that as the users interact with the first service 122, more accurate classifications may be obtained from the behavioral classification model. In one or more embodiments, the re-training may be done periodically (e.g., weekly, monthly, quarterly, semi-annually or yearly) as part of a maintenance or background feature of the first service 122.

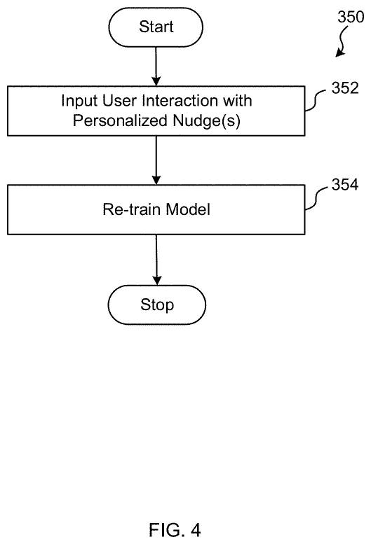

One process 350 for re-training the behavioral classification model is illustrated in FIG. 4. Similar to process 300, process 350 may be performed by the system 100. For example, first server 120 may execute the steps of the process 350 as part of the first service 122 and or as part of a maintenance or background feature of the first service 122. The first server 120 and or first service 122 may input and or use data from, or store processed data in, one or more of the first database 124, second database 144 and or user device 150.

At step 352, the process 350 may input user interactions with the personalized nudges. The interactions may consist of the opening of the message containing the nudge, the clicking on one or more links within the nudge and or the creation of a savings goal in response to the nudge, to name a few. This new interaction information may then be included in the training dataset and used at step 354 to retrain the behavioral classification model. Thus, the process 350 may further refine the behavioral classification model with actual use case data.

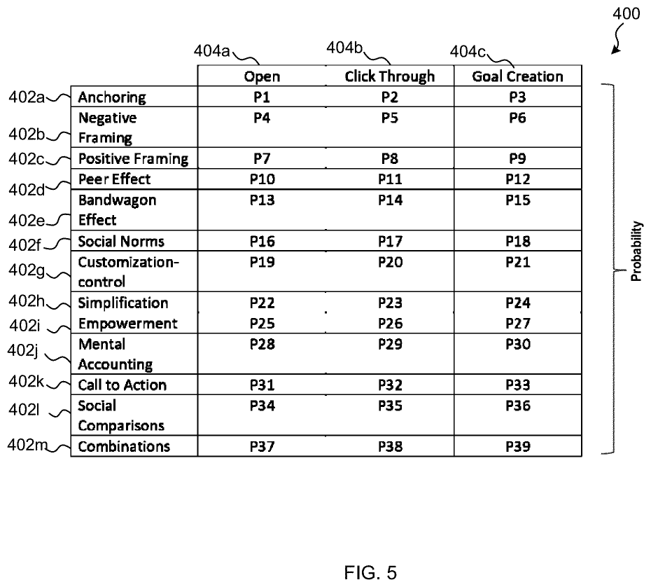

FIG. 5 shows an example evaluation matrix 400 that may be used in the behavioral-based personalized nudges process 300 disclosed herein. The illustrated example includes one axis or a set of rows 402a-402m associated with the behavioral principles used in the process 300. In addition, the illustrated matrix 400 includes another axis or a set of columns 404a, 404b, 404c associated with possible nudge interactions (e.g., opening the nudge, clicking through the nudge, creation of a savings goal, etc.). The intersection of the axes (rows 402a-402m and columns 404a, 404b, 404c) can be considered cells or matrix entries, which will be filled with the probabilities P1-P39 derived from the behavioral classification model's confidence levels as discussed above. It should be appreciated that the illustrated matrix 400 is merely an example and is not intended to limit the size of the evaluation matrix or the number of behavioral principles or user interactions used during the process 300.

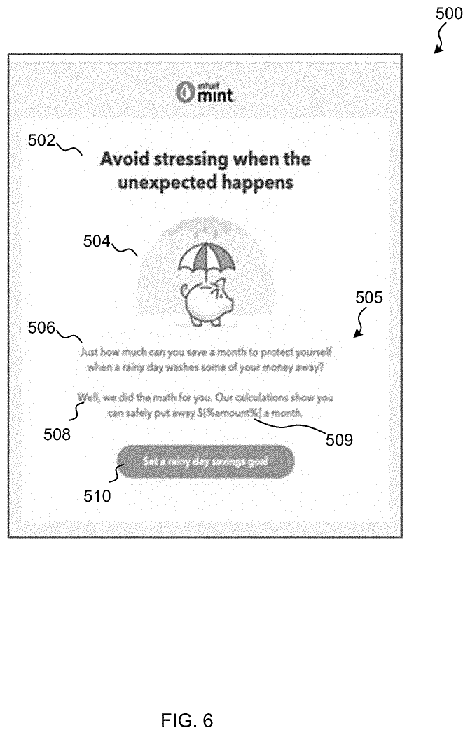

FIG. 6 shows an example nudge 500 that may be provided in accordance with the disclosed principles. The illustrated nudge 500 is an example of a nudge based on negative framing (i.e., a negative framing nudge). To that end, the nudge 500 includes a header portion 502 with an announcement or other text (“Avoid stressing when the unexpected happens”) that may be designed for users that respond well to negative framing.

The nudge 500 may also contain a graphic 504 and a message portion 505 to further illustrate the purpose of the nudge (e.g., starting a rainy day fund). For example, the illustrated message portion 505 includes first text 506 posing a query for the user (“Just how much can you save a month to protect yourself when a rainy day washes some of your money away?”) and second text 508 (“Well we did the math for you. Our calculations show you can safely put away $[% amount %] a month”) providing a system generated answer to the query. In the illustrated example, a system generated savings amount 509 (shown as “$[% amount %]” for convenience purposes only) is populated within the second text 508 to inform the user of an amount that he or she may save on a monthly basis.

The illustrated nudge 500 also includes a selector element 510 allowing the user to interact with the nudge 500 and engage with or activate a service of the financial service. In the illustrated example, the selector element 510 includes text (“Set a rainy day savings goal”) allowing the user to create a savings intention, which in this example is a rainy day savings goal. It should be appreciated that if the user activates the selector element 510, the selection may be used by process 350 to re-train the behavioral classification model.

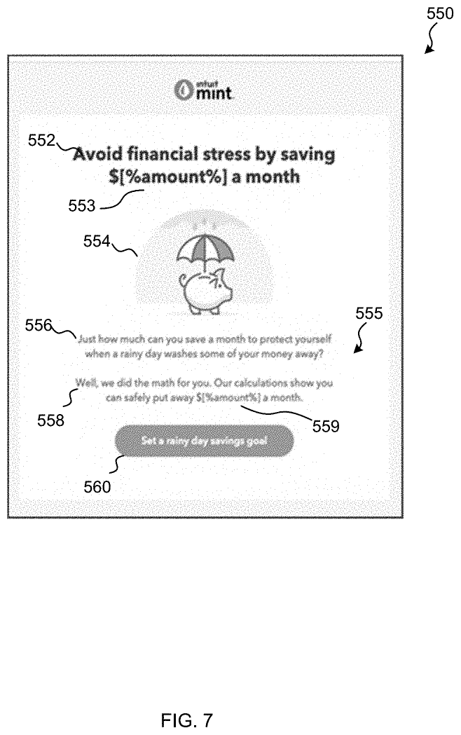

FIG. 7 shows an example nudge 550 that may be provided in accordance with the disclosed principles. The illustrated nudge 550 is an example of a nudge based on two behavioral principles: negative framing and anchoring (i.e., a negative framing with anchoring nudge). To that end, the nudge 550 includes a header portion 552 with an announcement or other text (“Avoid financial stress by saving $[% amount %] a month”) that may be designed for users that respond well to negative framing and anchoring. In the illustrated example, the header portion 552 includes an anchor in the form of a specific system generated savings amount 553 (shown as “$[% amount %]” for convenience purposes only).

The nudge 550 may also contain a graphic 554 and a message portion 555 to further illustrate the purpose of the nudge (e.g., starting a rainy day fund). For example, the illustrated message portion 555 includes first text 556 posing a query for the user (“Just how much can you save a month to protect yourself when a rainy day washes some of your money away?”) and second text 558 (“Well we did the math for you. Our calculations show you can safely put away $[% amount %] a month”) providing a system generated answer to the query. In the illustrated example, a system generated savings amount 559 (shown as “$[% amount %]” for convenience purposes only) is populated within the second text 558 to inform the user of an amount that he or she may save on a monthly basis.

The illustrated nudge 550 also includes a selector element 560 allowing the user to interact with the nudge 550 and engage with or activate a service of the financial service. In the illustrated example, the selector element 560 includes text (“Set a rainy day savings goal”) allowing the user to create a savings intention, which in this example is a rainy day savings goal. It should be appreciated that if the user activates the selector element 560, the selection may be used by process 350 to re-train the behavioral classification model.

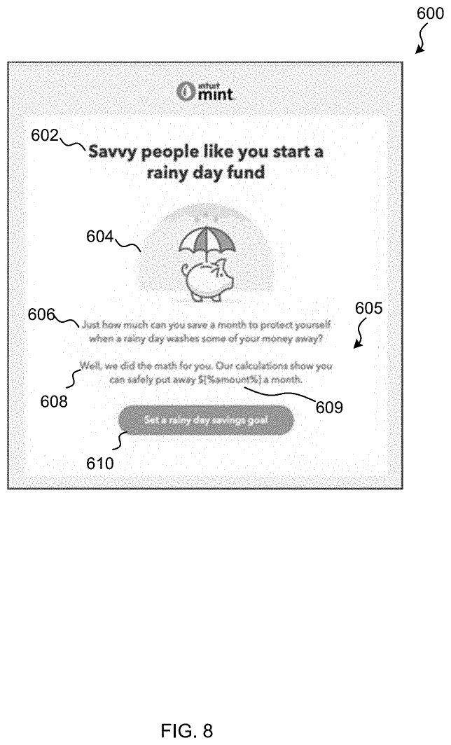

FIG. 8 shows an example nudge 600 that may be provided in accordance with the disclosed principles. The illustrated nudge 600 is an example of a nudge based on peer effect (i.e., a peer effects nudge). To that end, the nudge 600 includes a header portion 602 with an announcement or other text (“Savvy people like you start a rainy day fund”) that may be designed for users that respond well to peer effects.

The nudge 600 may also contain a graphic 604 and a message portion 605 to further illustrate the purpose of the nudge (e.g., starting a rainy day fund). For example, the illustrated message portion 605 includes first text 606 posing a query for the user (“Just how much can you save a month to protect yourself when a rainy day washes some of your money away?”) and second text 608 (“Well we did the math for you. Our calculations show you can safely put away $[% amount %] a month”) providing a system generated answer to the query. In the illustrated example, a system generated savings amount 609 (shown as “$[% amount %]” for convenience purposes only) is populated within the second text 608 to inform the user of an amount that he or she may save on a monthly basis.

The illustrated nudge 600 also includes a selector element 610 allowing the user to interact with the nudge 600 and engage with or activate a service of the financial service. In the illustrated example, the selector element 610 includes text (“Set a rainy day savings goal”) allowing the user to create a savings intention, which in this example is a rainy day savings goal. It should be appreciated that if the user activates the selector element 610, the selection may be used by process 350 to re-train the behavioral classification model.

As can be appreciated, the disclosed systems and processes provide several advantages over conventional electronic financial services. For example, there are no financial systems or services that use a machine learning model based recommendation system that automatically assigns nudges and behavioral economics principles to specific users with the goal of maximizing the users' interaction with the system/service. As can be appreciated, initiating a savings intention and increasing user interaction with the financial system/service, makes it easier for users to improve their debt situation by improving spending and savings habits and or create savings to be used in an emergency.

The disclosed principles use a machine learning behavioral classification model that is initially trained based on the behavioral principles that engaged select predetermined users with a positive net cash-flow and or no credit card debt (e.g., users with good financial habits). As can be appreciated, limiting the initial training of the machine learning behavioral classification model to these select users causes the model to be trained with data more likely to lead to the users creating savings intentions and or increasing engagement with the service. Thus, the model's output will be more accurate. In addition, limiting the initial training of the machine learning behavioral classification model to select users, as opposed to millions of users, speeds up the training and uses less storage resources than if data from every system/service user was included in the training dataset.

The behavioral classification model maybe automatically retrained based on user interactions with nudges previously used by the disclosed system and process to engage its users. Accordingly, accuracy of the machine learning behavioral classification model may be increased over time and in an efficient manner using actual use case data and engagement from users. As disclosed herein, personalized behavior-based nudges are developed using machine learning predictions and or probabilities that specific users will engage with the nudges. In addition, nudges based on more than one behavioral principle may be created and provided to users that are predicted to respond to such nudges. Any interaction with the nudges may lead the users to develop and or further its savings intentions (e.g., a savings goal, an emergency fund, etc.). As such, the disclosed systems and processes are an advancement in the electronic financial services fields.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A computer implemented method for providing personalized financial nudges to users of a financial service, said method being performed on a computing device, said method comprising:
inputting data associated with a user of the financial service into a behavioral classification model that was trained with test data associated with a plurality of behavioral principles and a plurality of select users of the financial service;
running the behavioral classification model for each one of the plurality of behavioral principles to generate a plurality behavior-based nudge probabilities, each behavior-based nudge probability corresponding to a probability that the user may use a respective one of a plurality of nudge interactions in response to a nudge based on a respective one of the plurality of behavioral principles;
generating a personalized nudge for the user based on one or more of the behavior-based nudge probabilities; and
outputting the personalized nudge to the user.

2. The method of claim 1, further comprising:
determining whether the user interacted with the personalized nudge; and
using the determined user interaction with the personalized nudge to re-train the behavioral classification model.

3. The method of claim 2, wherein said step of determining whether the user interacted with the personalized nudge to said step of using the determined user interaction with the personalized nudge to re-train the behavioral classification model are performed at a predetermined periodic rate.

4. The method of claim 1, wherein said personalized nudge comprises a message and said method further comprises determining whether the user interacted with the personalized nudge by determining whether the user opened the message.

5. The method of claim 1, wherein said personalized nudge comprises a selectable link and said method further comprises determining whether the user interacted with the personalized nudge by determining whether the user selected the selectable link.

6. The method of claim 1, further comprising determining whether the user interacted with the personalized nudge by determining whether the user initiated a service provided by the financial service.

7. The method of claim 1, further comprising:
generating an evaluation matrix comprising the plurality of behavior-based nudge probabilities from the model, the evaluation matrix comprises a plurality of rows associated with the plurality of behavioral principles and a plurality of columns associated with the plurality of nudge interactions, and intersections of the rows and columns comprise a respective behavior-based nudge probability; and
generating a personalized nudge for the user based on one or more of the behavior-based nudge probabilities within the evaluation matrix.

8. The method of claim 7, wherein generating the personalized nudge for the user based on one or more of the behavior-based nudge probabilities within the evaluation matrix comprises:
selecting at least one behavioral principle having a highest behavior-based nudge probability; and
generating at least one feature of the personalized nudge using text corresponding to the selected at least one behavioral principle.

9. The method of claim 1, further comprising:
conducting a behavioral test by sending a message comprising a test nudge to each of the select users;
inputting test results of the behavioral test; and
creating the test data based on the input test results and the data associated with the select users.

10. A system for providing personalized financial nudges to users of a financial service, said system comprising:
a first computing device configured to:
input data associated with a user of the financial service into a behavioral classification model that was trained with test data associated with a plurality of behavioral principles and a plurality of select users of the financial service;
run the behavioral classification model for each one of the plurality of behavioral principles to generate a plurality behavior-based nudge probabilities, each behavior-based nudge probability corresponding to a probability that the user may use a respective one of a plurality of nudge interactions in response to a nudge based on a respective one of the plurality of behavioral principles;
generate a personalized nudge for the user based on one or more of the behavior-based nudge probabilities; and
output the personalized nudge to the user.

11. The system of claim 10, wherein said first computing device is further configured to:
determine whether the user interacted with the personalized nudge; and
use the determined user interaction with the personalized nudge to re-train the behavioral classification model.

12. The system of claim 11, wherein said first computing device is configured to re-train the behavioral classification model at a predetermined periodic rate.

13. The system of claim 10, wherein said personalized nudge comprises a message and said first computing device is configured to determine whether the user interacted with the personalized nudge by determining whether the user opened the message.

14. The system of claim 10, wherein said personalized nudge comprises a selectable link and said first computing device is configured to determine whether the user interacted with the personalized nudge by determining whether the user selected the selectable link.

15. The system of claim 10, wherein said first computing device is configured to determine whether the user interacted with the personalized nudge by determining whether the user initiated a service provided by the financial service.

16. The system of claim 10, wherein said first computing device is configured to:
generate an evaluation matrix comprising the plurality of behavior-based nudge probabilities from the model, the evaluation matrix comprises a plurality of rows associated with the plurality of behavioral principles and a plurality of columns associated with the plurality of nudge interactions, and intersections of the rows and columns comprise a respective behavior-based nudge probability; and
generate a personalized nudge for the user based on one or more of the behavior-based nudge probabilities within the evaluation matrix.

17. The system of claim 16, wherein generating the personalized nudge for the user based on one or more of the behavior-based nudge probabilities within the evaluation matrix comprises:
selecting at least one behavioral principle having a highest behavior-based nudge probability; and
generating at least one feature of the personalized nudge using text corresponding to the selected at least one behavioral principle.

18. The system of claim 10, wherein said first computing device is configured to:
conduct a behavioral test by sending a message comprising a test nudge to each of the select users;
input test results of the behavioral test; and
create the test data based on the input test results and the data associated with the select users.
